(19) United States
(12) Patent Application Publication
(10) Pub. No.: US 2012/0237898 A1
(43) Pub. Date: Sep. 20, 2012

(54) MULTI-STAGE DENTAL IMPLANT

(75) Inventors: Ady PALTI, Baden Baden (DE); Ran Weizman, Kefar Veradim (IL); Shmuel Topaz, Haifa (IL)

(73) Assignee: PALTOP ADVANCED DENTAL SOLUTIONS LTD., Caesarea (IL)

(21) Appl. No.: 13/050,425

(22) Filed: Mar. 17, 2011

(51) Int. Cl. A61C 8/00

(52) U.S. Cl. 433/174

(57) ABSTRACT

A dental implant is provided having a longitudinal axis, and comprising an elongate body portion at an apical portion of the implant and a neck portion at a coronal portion of the implant. A first helical thread profile is around a first portion of the elongate body, at the apical portion. A second helical thread profile that is different from the first helical thread profile, is around a second portion of the elongate body that is between the first portion and the neck portion. The implant further comprises a third helical thread profile that is around the neck portion and that is different from both the first and second helical thread profiles. Other applications are also described.

### FIELD OF THE APPLICATION

Applications of the present invention relate generally to prosthetics and more specifically to dental implants.

### BACKGROUND OF THE APPLICATION

Dental implants typically consist of a screw-shaped structure that is used to replace a missing tooth root by implantation into a jaw of a subject. Dental implants may vary in length, diameter, and thread pattern.

Thread patterns are typically used to maximize contact between the implant and the bone, improve stability, enlarge implant surface area, and improve the dissipation of stresses along the implant. Accordingly, thread characteristics, e.g., thread type and/or thread pitch, typically affect the biomechanical load distribution around the implant.

Typically, an abutment to which a dental crown may be coupled, is inserted into an opening at the coronal portion of the implant following implantation of the dental implant. The abutment may have a diameter that is smaller than the diameter of the dental implant, at the area of the soft tissue, i.e., the gum, such that a technique known as “platform switching” may be applied. “Platform switching” was found to decrease vertical change in the crestal bone height around the dental implant, as described in an article by Lazzara et al., entitled: “Platform Switching: A New Concept in Implant Dentistry for Controlling ostrestorative Crestal Bone Levels”, International Journal of Periodontics & Restorative Dentistry., vol. 26, pp. 9-17, 2006).

### SUMMARY OF APPLICATIONS

In some applications of the present invention, a dental implant is provided having variable thread profiles along a longitudinal axis thereof. The implant comprises an elongate body portion at an apical portion of the implant and a neck portion at a coronal portion of the implant. Additionally, the implant comprises three distinct thread profiles which surround various portions of the implant along the longitudinal axis thereof.

Typically, a first helical thread profile is positioned around a first portion of the elongate body. A second helical thread profile that is different from the first helical thread profile, is positioned around a second portion of the elongate body. The second portion of the elongate body is located between the first portion and the neck portion. A third helical thread that is different from both the first and second helical thread profiles is typically positioned around the neck portion.

For some applications, the first helical thread profile is shaped to define a V-shape thread profile, and the second helical thread profile is shaped to define a double-slotted, double-leaded thread profile, as described hereinbelow. The third helical thread profile is typically shaped to define a fine-threaded profile, when compared to the first and second thread profiles.

For some applications, an abutment is configured for insertion into an opening in the coronal portion of the dental implant. Typically, the abutment is inserted into the implant following osseointegration of the implant, i.e., growth of bone which anchors the implant. The abutment is configured for coupling to the dental implant in a platform switching manner, by having appropriate dimensions which are typically smaller than the dental implant in the soft tissue area, i.e., the gum.

There is therefore provided in accordance with some applications of the present invention a dental implant having a longitudinal axis, the implant including:

an elongate body portion at an apical portion of the implant;

a neck portion at a coronal portion of the implant;

a first helical thread profile around a first portion of the elongate body, at the apical portion;

a second helical thread profile that is (a) different from the first helical thread profile, and (b) around a second portion of the elongate body that is between the first portion and the neck portion; and

a third helical thread profile that is around the neck portion and that is different from both the first and second helical thread profiles.

For some applications, the implant includes an abutment, and the implant is configured for coupling of the abutment in a platform switching manner.

For some applications, the first helical thread profile is shaped to define a V-shaped thread profile.

For some applications, the first helical thread is a double lead thread.

For some applications, the V-shaped thread has a pitch of 0.7-0.9 mm.

For some applications, the V-shaped thread has a pitch of 0.8 mm.

For some applications, the first helical thread is shaped to define progressive thread geometry along the longitudinal axis.

For some applications, the implant has a length of 6-16 mm.

For some applications, the first portion includes 25-50% of a length of the body portion.

For some applications, the first portion includes 35-40% of the length of the body portion.

For some applications, the second helical thread profile is shaped to define an apically-facing flat surface, a normal to the flat surface being generally parallel to the longitudinal axis of the implant.

For some applications, the second helical thread profile is further shaped to define one or more slots.

For some applications, the one or more slots include a first and a second slot and the first slot is provided at a crest of the second helical thread profile, and the second slot is provided at a root of the second helical thread profile.

For some applications, the second helical thread profile is a double lead thread.

For some applications, the second helical thread profile has a thread angle of 20-45 degrees.

For some applications, the second helical thread has a pitch of 0.6-1.5 mm.

For some applications, the second helical thread is shaped to define progressive thread geometry along the longitudinal axis.

For some applications, the second portion includes 35-60% of a length of the body portion.

For some applications, the first portion includes 40-53% of the length of the body portion.

For some applications, the third helical thread profile is shaped to define a fine-threaded profile, compared to the first and second thread profiles.

For some applications, the first helical thread profile is shaped to define a V-shape thread profile, and the second helical thread profile is shaped to define an apically-facing flat surface and to have one or more slots.

For some applications, the fine-threaded profile is shaped to define a four-lead thread.

For some applications, the fine-threaded profile includes V-shaped microthreads.

For some applications, the microthreads have a crest-to-root depth of 0.13-0.17 mm.

For some applications, the microthreads have a pitch of 0.3-0.5 mm.

For some applications, the microthreads have a pitch of 0.4 mm.

For some applications, the neck portion includes 12-20% of the length of the dental implant.

The present invention will be more fully understood from the following detailed description of applications thereof, taken together with the drawings, in which:

### BRIEF DESCRIPTION OF THE DRAWINGS

FIG. 1 is a schematic illustration of a dental implant in accordance with some applications of the present invention;

FIG. 2 is a schematic illustration of a longitudinal section of the dental implant of FIG. 1, in accordance with some applications of the present invention;

FIG. 3 is a top view of an internal hexagon in a coronal portion of the implant of FIG. 1 for receiving an abutment, in accordance with some applications of the present invention; and

FIG. 4 is a bottom view of the implant of FIG. 1, looking at the apical end of the implant, in accordance with some applications of the present invention.

### DETAILED DESCRIPTION OF APPLICATIONS

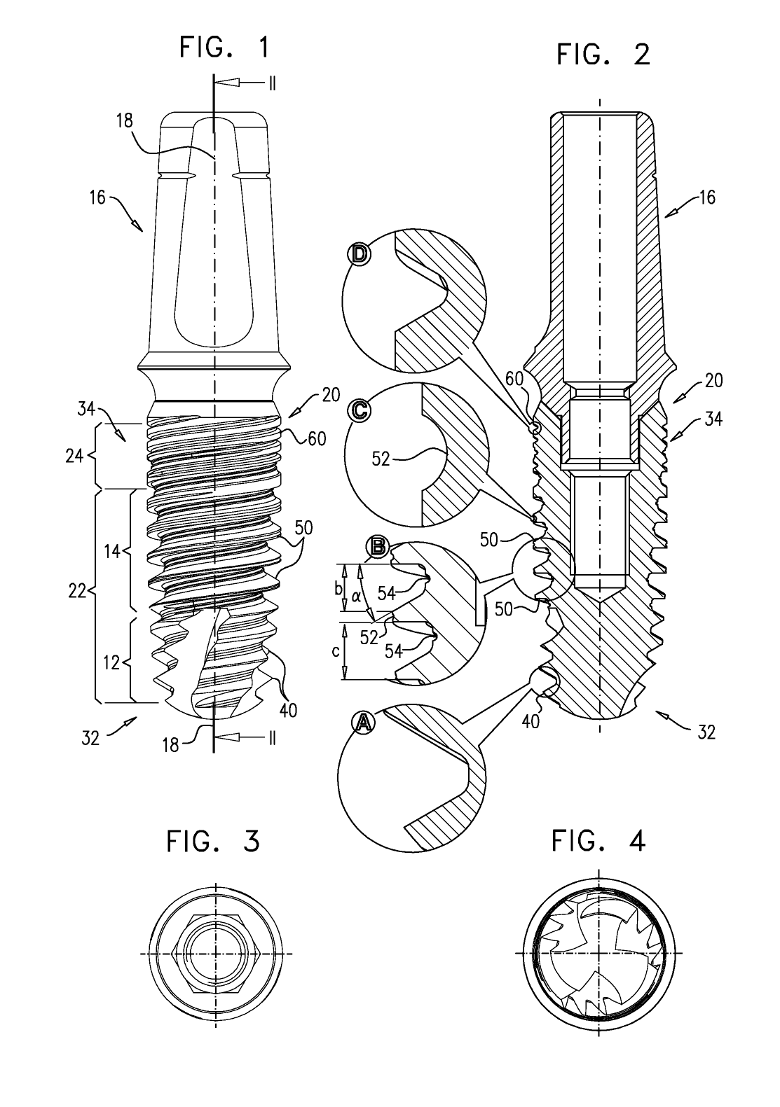

Reference is made to FIG. 1, which is a schematic illustration of a dental implant 20 for implantation and osseointegration in a jaw bone of a subject, as provided by some applications of the present invention. Dental implant 20 is typically shaped to define a cylindrical implant which may (or may not) be tapered over a portion of its length. Implant 20 comprises an apical portion 32 and a coronal portion 34. The implant comprises an elongate body 22 portion at apical portion 32 of the implant, and a neck portion 24 at coronal portion 34 of implant 20. For some applications, dental implant 20 has a length of 6-16 mm.

As provided by some applications of the present invention, an outer surface of the implant comprises threading which facilitates placement and firm implantation of implant 20 into the jaw of the subject. Dental implant 20 typically has multiple thread profiles along a longitudinal axis 18 thereof. In particular, for some applications, implant 20 comprises three distinct thread profiles which surround various portions of the implant along longitudinal axis 18.

As shown in FIG. 1, a first helical thread profile is positioned around a first portion 12 of elongate body 22 at apical portion 32, and a second helical thread profile that is different from the first helical thread profile, is positioned around a second portion 14 of elongate body 22. As shown, second portion 14 is located between first portion 12 and neck portion 24. A third helical thread that is different from both the first and second helical thread profiles is typically positioned around neck portion 24.

Reference is now made to both FIGS. 1 and 2. For some applications, the first helical thread profile is shaped to define a V-shaped thread 40, such that first portion 12 comprises V-shaped threading. FIG. 2 shows an enlarged view A of V-shaped thread 40, which surrounds portion 12.

As described hereinabove, first portion 12 of elongate body is located at apical portion 32 of implant 20. For some applications, first portion 12 comprises about 25-50%, e.g., 35-40% of the length of body portion 22. For some applications, V-shaped thread 40 is a double lead thread, having a pitch of 0.7-0.9 mm (e.g., 0.8 mm), and a corresponding lead of 1.4-1.8 mm (e.g., 1.6 mm).

Typically, first portion 12 is the first part of implant 20 to come in contact with the bone of the jaw during the implantation process, and V-shaped thread 40 facilitates insertion of implant 20 into the bone. V-shaped threads are typically known for their ability to facilitate advancement of an implant through the bone and are generally suitable for different bone types.

For some applications, the second helical thread profile comprises a thread 50 shaped to define a wide flat surface that faces the apical end of the implant. In other words, a normal to the plane defined by the apically-facing flat surface is generally parallel to the longitudinal axis of implant 20. This flat surface provides increased surface area and improved axial load distribution. Thread 50 is typically further shaped to define a “double-slotted” double-lead thread for further increasing surface area of implant 20.

Accordingly, second portion 14 comprises double-slotted and double-lead threading. “Double-slotted” indicates that a slot 52 is provided at the crest of second thread 50, and a slot 54 is provided at the root of second thread 50. It is noted that for some applications, the implant includes only one or the other of the slots. Second portion 14 typically bears a large amount of the applied loads, and is configured to distribute the load to the bone. Typically, thread 50 facilitates load distribution and provides increased stability to implant 20. Generally, this double-slotted, double-lead thread, may improve distribution of axial chewing loads by transforming them into a variety of vectors to the bone. Thread profile 50 typically creates an increased implant surface area compared to other known thread profiles, thereby increasing the bone implant contact (BIC) area, which is considered to be an important factor in the implant long term survivability.

FIG. 2 shows enlarged views B and C of double-slotted, double-lead threading 50 which surrounds portion 14. For some applications, threading 50 has a thread angle alpha of 20-45 degrees, a thread span b of 0.4-1.5 mm, and/or a thread pitch c of 0.6-1.5 mm (corresponding to a lead of 1.2-3 mm).

As described hereinabove, second portion 14 of elongated body 22 is located between first portion 12 and neck portion 24. For some applications, second portion 14 comprises about 30-60%, e.g., 40-53% of the length of body portion 22.

It is noted that the thread profiles described herein with reference to first portion 12 and/or second portion 14 typically but not necessarily have progressive thread geometry along a length thereof (i.e., the thickness of the thread increases when measured closer to the coronal end of implant 20), thereby increasing mechanical primary stability of implant 20.

For some applications, the third helical thread profile is shaped to define microthreads 60, such that neck portion 24 at coronal portion 34 of implant 20 comprises microthreads 60. The coronal portion of implant 20 is typically implanted in the cortical bone which is a generally hard and dense bone. Microthreads 60 have a fine thread profile and are configured to reduce stress between neck portion 24 and the bone, and additionally distribute forces transferred to the surrounding bone, thereby decreasing the amount of coronal bone loss.

Microthreads 60 typically comprise V-shaped microthreads having a crest-to-root depth of 0.15 mm (+/−0.02 mm) and a pitch of 0.3-0.5 mm, e.g., 0.4 mm (and a corresponding lead of 1.2-2.0 mm, e.g., 1.6 mm, for applications in which microthreads 60 are four-leaded).

FIG. 2 shows an enlarged view D of microthreads 60 at neck portion 24 of implant 20. For some applications, neck portion 24 comprises 12-20% of the length of implant 20.

It is noted that the combination of the three distinct thread profiles as described herein typically provides an improved dental implant 20, which typically provides immediate and early loading in a large range of clinical cases.

Reference is again made to FIGS. 1 and 2. For some applications, following integration of implant 20 into the jaw bone, an abutment 16 is inserted into implant 20. For some applications, implant 20 is shaped to define an internal elongated bored cavity along longitudinal axis 18. The opening of the cavity is at coronal portion 34 of the implant 20. Abutment 16 is configured for insertion into the elongated cavity through the opening in coronal portion 34. Typically, the internal elongated cavity has a diameter that allows insertion of an abutment of matching diameter. However, abutment 10 typically has a smaller diameter than that of the internal cavity, configuring it for coupling to the dental implant in a platform switching manner.

FIG. 3 is a top view of an internal hexagon in a coronal portion of the implant of FIG. 1 for receiving an abutment, in accordance with some applications of the present invention.

FIG. 4 is a bottom view of the implant of FIG. 1, looking at the apical end of the implant, in accordance with some applications of the present invention.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A dental implant having a longitudinal axis, and comprising:
an elongate body portion at an apical portion of the implant;
a neck portion at a coronal portion of the implant;
a first helical thread profile around a first portion of the elongate body, at the apical portion;
a second helical thread profile that is (a) different from the first helical thread profile, and (b) around a second portion of the elongate body that is between the first portion and the neck portion; and
a third helical thread profile that is around the neck portion and that is different from both the first and second helical thread profiles.

2. The dental implant according to claim 1, further comprising an abutment, wherein the implant is configured for coupling of the abutment in a platform switching manner.

3. The dental implant according to claim 1, wherein the first helical thread profile is shaped to define a V-shaped thread profile.

4. The dental implant according to claim 3, wherein the first helical thread is a double lead thread.

5. The dental implant according to claim 3, wherein the V-shaped thread has a pitch of 0.7-0.9 mm.

6. The dental implant according to claim 5, wherein the V-shaped thread has a pitch of 0.8 mm.

7. The dental implant according to claim 3, wherein the first helical thread is shaped to define progressive thread geometry along the longitudinal axis.

8. The dental implant according to claim 3, wherein the second helical thread profile is shaped to define an apically-facing flat surface, a normal to the flat surface being generally parallel to the longitudinal axis of the implant and further shaped to define one or more slots.

9. The dental implant according to claim 1, wherein the first portion comprises 25-50% of a length of the body portion.

10. The dental implant according to claim 9, wherein the first portion comprises 35-40% of the length of the body portion.

11. The dental implant according to claim 1, wherein the second helical thread profile is shaped to define an apically-facing flat surface, a normal to the flat surface being generally parallel to the longitudinal axis of the implant.

12. The dental implant according to claim 11, wherein the second helical thread profile is further shaped to define one or more slots.

13. The dental implant according to claim 12, wherein the one or more slots comprise a first and a second slot and wherein the first slot is provided at a crest of the second helical thread profile, and wherein the second slot is provided at a root of the second helical thread profile.

14. The dental implant according to claim 11, wherein the second helical thread profile has a thread angle of 20-45 degrees.

15. The dental implant according to claim 11, wherein the second helical thread profile is a double lead thread.

16. The dental implant according to claim 11, wherein the second helical thread has a pitch of 0.6-1.5 mm.

17. The dental implant according to claim 11, wherein the second helical thread is shaped to define progressive thread geometry along the longitudinal axis.

18. The dental implant according to claim 1, wherein the implant has a length of 6-16 mm.

19. The dental implant according to claim 1, wherein the second portion comprises 35-60% of a length of the body portion.

20. The dental implant according to claim 19, wherein the second portion comprises 40-53% of the length of the body portion.

21. The dental implant according to claim 1, wherein the third helical thread profile is shaped to define a fine-threaded profile, compared to the first and second thread profiles.

22. The dental implant according to claim 21, wherein the first helical thread profile is shaped to define a V-shape thread profile, and wherein the second helical thread profile is shaped to define an apically-facing flat surface and to have one or more slots.

23. The dental implant according to claim 21, wherein the fine-threaded profile is shaped to define a four-lead thread.

24. The dental implant according to claim 21, wherein the fine-threaded profile comprises V-shaped microthreads.

25. The dental implant according to claim 24, wherein the microthreads have a crest-to-root depth of 0.13-0.17 mm.

26. The dental implant according to claim 24, wherein the microthreads have a pitch of 0.3-0.5 mm.

27. The dental implant according to claim 26, wherein the microthreads have a pitch of 0.4 mm.

28. The dental implant according to claim 1, wherein the neck portion comprises 12-20% of the length of the dental implant.
